(19) United States
(12) Patent Application Publication
(10) Pub. No.: US 2005/0255874 A1
(43) Pub. Date: Nov. 17, 2005

(54) Motion disabled cell phone method

(76) Inventors: Marie Stewart-Baxter, Santa Clarita, CA (US); Fred H. Holmes, Cleveland, OK (US)

Correspondence Address: MARIE STEWART-BAXTER, 28348 NICHOLAS CIRCLE, SANTA CLARITA, CA, 91350, US

(21) Appl. No.: 11/115,038

(22) Filed: Apr. 26, 2005

(51) Int. Cl. H04M 1/66

(52) U.S. Cl. 455/550.1

(57) ABSTRACT

A system and method for detecting motion of a cell phone and disabling the use of the cell phone while moving or driving. The inventive system includes: a cell phone; a sensor to detect motion of the cell phone; software in the cell phone to disable the use of the cell phone when motion is detected. In a preferred embodiment, the system also recognizes the near proximity of an automobile and disables the use of the cell phone in this near proximity.

### BACKGROUND OF THE INVENTION

1. Field of the Invention

The present invention relates to a system and method for limiting unsafe use of a cell phone. More particularly, but not by way of limitation, the present invention relates to a method for determining when a cell phone is being used in a driving situation and selectively disabling communication features while the cell phone is used in a driving situation.

2. Background of the Invention

Generally speaking, there is a long felt need for a method to disable the use of a cell phone while driving. Many large cities or States have enacted prohibitions against driving while using a cell phone or, at least, a hand held cell phone. Cell phone related accidents have become a plague of epidemic proportions. It is estimated that roughly 50,000 Americans die each year in traffic related deaths with many times that number of non-fatal injuries. A growing percentage of these deaths and accidents are in some way related to cell phone use. Driving novices such as teenagers are acutely at risk because they are uniquely familiar with cell phones and lacking sufficiently in driving skills. In fact it has recently been reported that teens using cell phones drive in the same manner as the elderly. Unfortunately, at present there is no solution to the problem except through legislation and it is questionable whether such laws are actually effective.

It is thus an object of the present invention to provide a method of disabling a cell phone while driving without incurring undue costs in a handset, infrastructure, and recurring costs.

It is a further object of the present invention to provide a method of disabling a cell phone while driving without requiring a specialized cell phone to do so.

It is still a further object of the present invention to provide a method of disabling a cell phone while driving which has provisions for emergency usage.

It is still a further object of the present invention to provide a method of disabling all cell phones which are moving without requiring special cell phones to do so in a particular geographical region.

### SUMMARY OF THE INVENTION

The present invention provides a system and method for disabling a cell phone while moving. In preferred embodiments, the inventive method includes: a cell phone; a motion detecting sensor in the cell phone, such as an accelerometer or GPS receiver; or a short range wireless connection that detects an enabled car and software which disables communications features of the cell phone when motion is detected. Optionally 911 and other pre-approved calls such as phone calls to parent's phone numbers could be made at all times and would not be disabled by motion detection. Calls would be allowed while in motion if the phone detected insertion into a hands-free docking station. To deactivate communication, preferably the detected speed would have to exceed a threshold such that the phone could still be used while walking, running, etc. and such that positional “noise” from the motion detector does not cause false deactivations.

As is well known in the art, cell phone manufacturers and service providers have developed a number of schemes for determining the location of a cell phone, at least to within a few hundred feet, but only after pressure from the government in furtherance of 911 emergency services. In some cases, service providers have gone on to use this information to provide geographically targeted advertising or features. While such positional information has not been used to limit operation of a cell phone under unsafe conditions, with appropriate conditioning such information could be employed in certain embodiments of the present invention to achieve motion detection.

Thus, in other preferred embodiments, the inventive system includes: a cell phone; an array of cell towers with communications between themselves; software in the service provider's system which tracks a cell phone's location based either on time-of-flight and/or relative signal strengths to determine a cell phone velocity; and a system for preventing operation of a cell phone when a velocity threshold is exceeded. Ideally the tower based motion detecting software would have a speed threshold greater than that which is usually associated with jitter as to avoid false detection of movement.

In another preferred embodiment, the inventive method includes: a cell phone; a cell phone based communications link such as Blue Tooth; a car mounted transmitter configured for communication with the cell phone; and software which disables communications features of the cell phone when an in-operation signal is received from the car mounted transmitter. This system could disable the cell phone anytime the phone is in the owner's car with the car running. Further, such a system does not require additional hardware within the cell phone, since many cell phones are presently Blue Tooth enabled, or require local service provider cooperation.

Further objects, features, and advantages of the present invention will be apparent to those skilled in the art upon examining the accompanying drawings and upon reading the following description of the preferred embodiments.

### BRIEF DESCRIPTION OF THE DRAWINGS

FIG. 1 depicts the inventive system in its general environment.

FIG. 2 provides a block diagram of a cell phone in accordance with a preferred embodiment of the inventive system.

FIG. 3 provides a block diagram of a cell phone motion detection system according to a preferred embodiment of the inventive system.

FIG. 4 depicts a motion detection system wherein the service provider detects cell phone motion.

FIG. 5 provides a flow chart for motion disabling of a cell phone.

FIG. 6 provides a block diagram of a cell phone disable according to a wirelessly transmitted message from a vehicle.

### DESCRIPTION OF THE PREFERRED EMBODIMENTS

Before explaining the present invention in detail, it is important to understand that the invention is not limited in its application to the details of the construction illustrated and the steps described herein. The invention is capable of other embodiments and of being practiced or carried out in a variety of ways. It is to be understood that the phraseology and terminology employed herein is for the purpose of description and not of limitation.

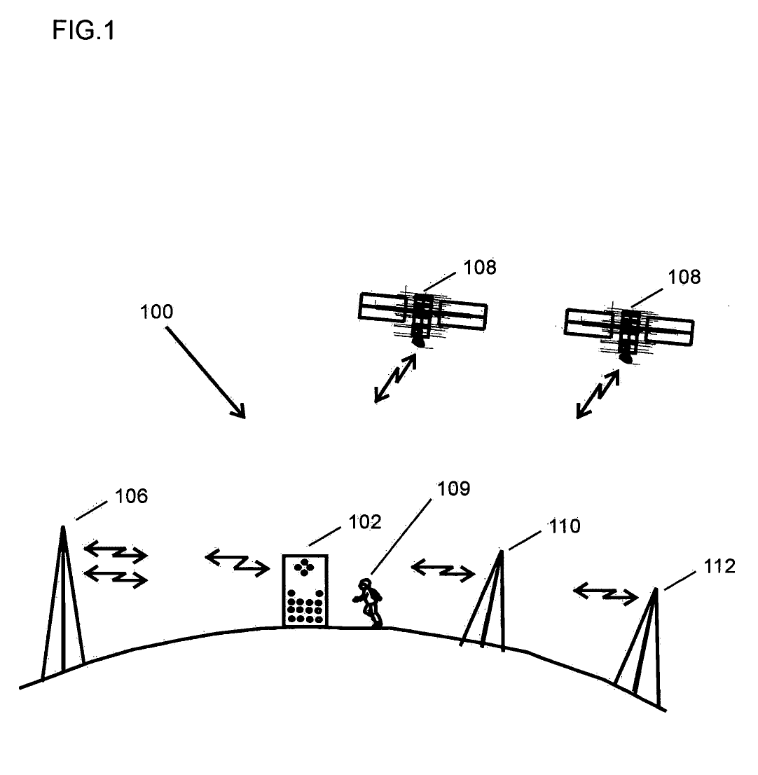

Referring now to the drawings, wherein like reference numerals indicate the same parts throughout the several views, a preferred embodiment of the inventive system is shown in its general environment in FIG. 1. Typically, a cell phone 102 is used by a person 109 to make telephone calls in much the same way as a wire-based telephone. With a cell phone, however, phone 102 communicates wirelessly with a cell site, such as indicated by tower 106. In practice, an area with cell phone coverage is divided into cells, each cell being serviced by a single tower 106, 108, and 112. As subscriber 109 moves around, the service provider automatically switches the user to the tower with the highest quality signal.

As will be recognized by those skilled in the art, subscription-based wireless phones have taken on a number of different names, by way of example and not limitation: cell phones, PCS phones, CDMA phones, TDMA phones, analog phones, GSM phones, digital phones, etc. For purposes of this invention, any wireless mobile phone is referred to simply as a “cell phone” and the present invention is suitable for use with any type of such phone.

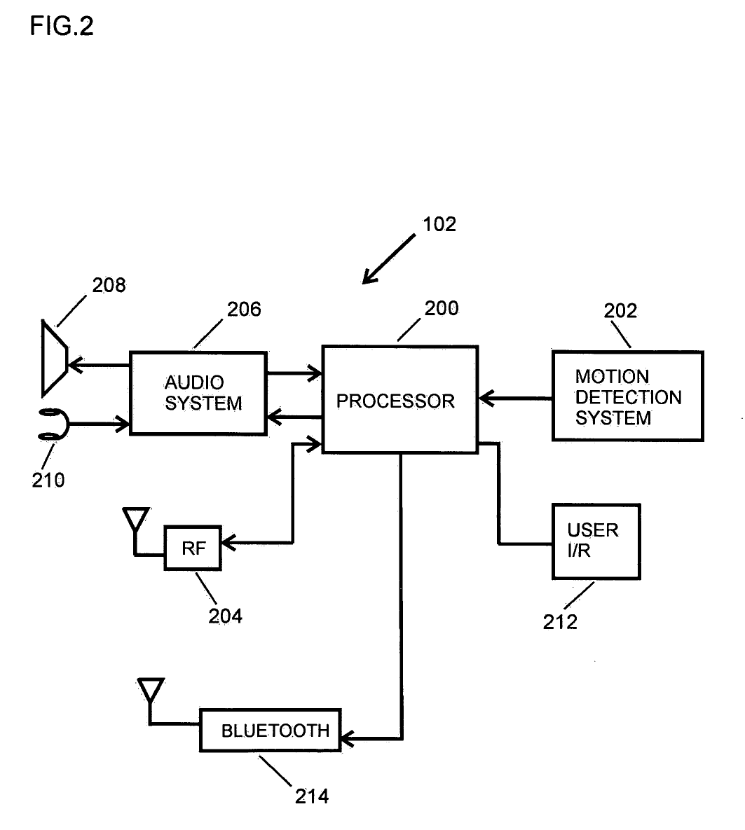

With further reference to FIG. 2, regardless of the phone technology employed, a typical cell phone 102 includes: a microphone 208 for receiving acoustic information from a user 109; a speaker or headphone 210 for outputting audio to the user 109; an audio system 206 comprising at least an amplifier for the signal from microphone 208, an amplifier for speaker 210, and possibly anti-aliasing filtering for the incoming audio signal for digital cell phones; processor 200 for managing operation of the phone 102; a radio (“RF”) system 204 for wireless communication with the service provider; and a user interface 212 for interaction with user 109. Such cell phones are well known in the art and a detailed discussion of the operation of such phones is unnecessary to understand the present invention.

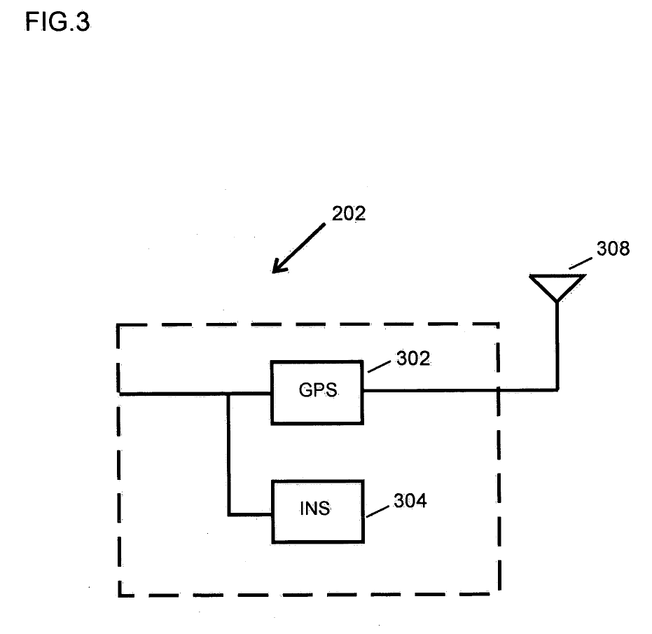

In one preferred embodiment of the present invention, cell phone 102 further includes a motion detection system 202. With further reference to FIG. 3, motion detection system 202 may comprise either a GPS receiver 302 along with its accompanying antenna 308, an inertial system 304, or a combination thereof. GPS receivers are well known in the art and, in fact, an ever increasing number of cell phones already include an embedded GPS receiver. Generally speaking, GPS receivers receive timing information from a plurality of GPS satellites, as represented by satellites 108. Presently there are 24 active satellites 108 in the GPS constellation but GPS receiver 302 only needs to be able to receive signals from three or more satellites 108 to provide a position fix in two dimensions. As will be apparent to those skilled in the art, velocity of the GPS receiver 302 can easily be determined by finding the change in position with respect to time (the first order differential). A determination of motion using this GPS technique would then disable the calling and receiving capability of a phone 102 with motion detection capabilities 202, likewise the absence of position change would re-enable the calling and receiving capability of the cell phone.

An alternative preferred embodiment of the present invention employs a cell phone with an inertial system 304, the determination of motion using an integrated accelerometer, or similar motion detector, would then disable the phone's 202 calling and receiving capability. Likewise the absence of position change would re-enable the calling and receiving capability of the cell phone 102 if it had motion detecting capabilities 202.

In FIG. 2 cell phones 102 have a variety of functions and hardware such as integral cameras, Blue Tooth, wireless headsets, e-mail, and ring programmability which could be used or disabled if motion is detected. Blue Tooth 214 is a very short range, rarely more than 20 feet, radio communications scheme that is largely used in communicating with wireless headsets. Newer uses for cell phone based Blue Tooth 214 and other wireless schemes such as Ultra-wideband 214 are being touted as automatic commerce or communication with vending machines, ATMs, gas pumps, and door locks. You can walk up to a vending machine press a button and the machine will wirelessly and automatically bill your credit card or phone. Walk up to your house and the door automatically unlocks. Cars are now employing these wireless interfaces as well.

There are existing methods to determine the location of a cell phone 102 in accordance with E911 requirements. The E911 requirements were enacted to provide the location of a cell phone to emergency workers when a cell phone user dials “911”. The primary approaches of these methods rely on either a Global Positioning System (GPS), signal strength between cell towers, or “time of flight”. GPS location systems are well known in the art and determine a cell phone's position within about 5 meters. GPS provides one of the best, but also expensive, options requiring a special phone with a GPS engine inside. The GPS engine is usually off to save power and is turned on only when the 911 feature is activated or by the cell phone user to determine a location when lost.

A different method using, “received signal strength indication” (RSSI), is well known in the art. This system can only provide an estimate of a cell 102 phone location, typically within about 1000 feet, but is widely favored in older installations as it generally only requires a cell-site software upgrade. Each cell tower 106 communicates with adjacent towers 110 and 112 regarding which of the directional antennae it is using and the corresponding RSSI signal from a single cell phone 102. From the collected information, the system approximates the cell phone's location. This is the least desirable location method because large buildings and structures can block signals to a nearby cell tower while the view to a further tower is unobstructed, which combined yield a false location.

In another preferred embodiment, the apparent location provided by RSSI could be tracked by the cell phone service provider and it will be apparent to those skilled in the art, velocity of the cell phone 102 can easily be determined by finding the change in position with respect to time (the first order differential). A determination that the cell phone was moving would result in a condition that would allow the provider to disable the cell phone's service or send a signal to the cell phone which would disable the phone's 102 calling and receiving capability. Likewise the absence of position change would re-enable the calling and receiving capability of the cell phone 102.

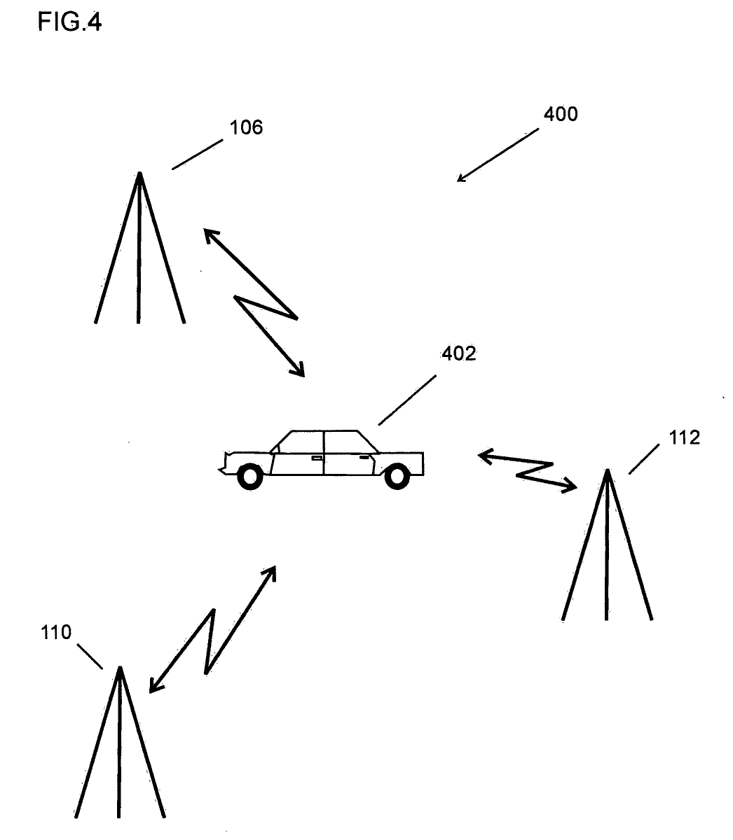

FIG. 4 illustrates “Time of flight” (ToF) systems which are well known in the art and determine how long it takes a radio signal to travel from the cell phone in a car 402 to the closest towers 106 and 110 and 112. This information is used in a timed triangulation scheme to determine location. Because radio signals travel at the speed of light and the distance of flight is relatively short, this ToF method requires special and expensive hardware at the cell sites but not special cell phones. The ToF system works around and under tall buildings where GPS might not work but isn't quite as accurate as GPS in practice.

In another preferred embodiment, the apparent location provided by a ToF system could be tracked by the cell phone service provider and, as will be apparent to those skilled in the art, velocity of the cell phone 102 can easily be determined by finding the change in position with respect to time (the first order differential). A determination that the cell phone was moving would result in a condition that would allow the provider to disable the cell phone's service or send a signal to the cell phone which would disable the phone's 102 calling and receiving capability. Likewise the absence of position change would re-enable the calling and receiving capability of the cell phone 102.

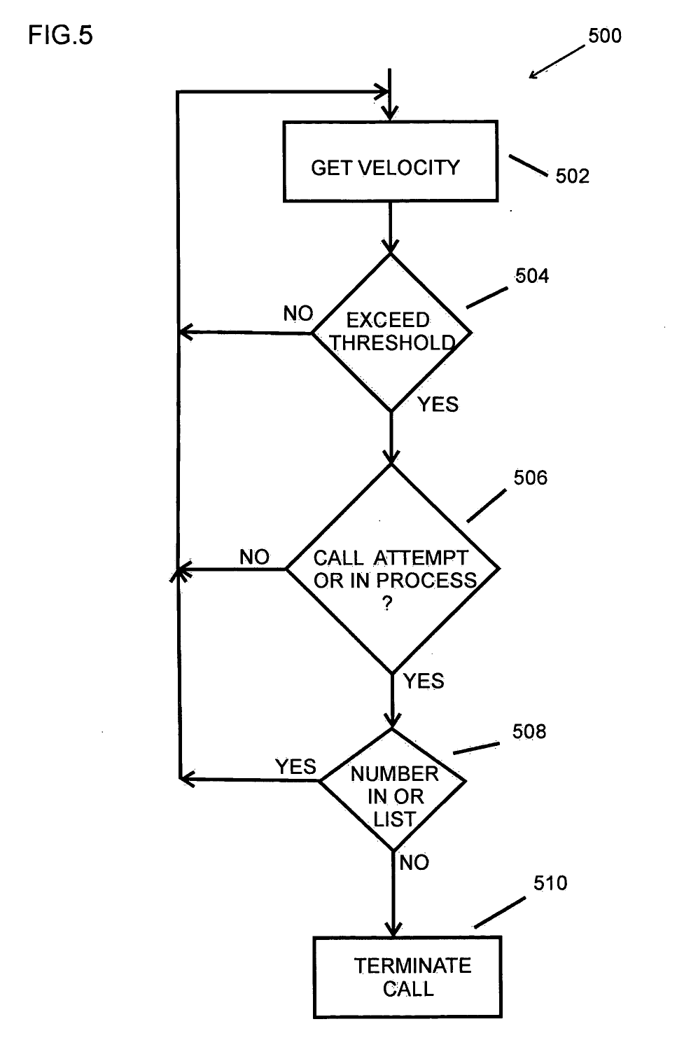

One preferred method 500 for practicing the present invention is shown in the flow chart of FIG. 5. A loop for monitoring the motion status of a cell phone starts at step 502 wherein the velocity of the cell phone is obtained. As will be apparent to those skilled in the art from the discussion hereinabove, such velocity may be calculated internally at the cell phone through, for example, integrated accelerometers, the output of a GPS receiver, or the like; or by the service provider through time of flight, relative RSSI, or the like. For the purposes of this invention, how the velocity is obtained is unimportant, only that an approximate value of the velocity is obtained.

At step 504, the velocity retrieved in step 502 is compared to a threshold, or limit, to see if the cell phone is in motion at a velocity which is indicative of use in an automobile. If the velocity is below the threshold, the process returns to monitor the speed at step 502. If the speed of the cell phone exceeds the threshold, at step 506 it is determined if: the user is attempting a call; or a call is already in progress. If neither condition exists, the process returns to step 502 to monitor the speed of the cell phone. If a call is in progress or being attempted, the phone number is compared against a list of allowed telephone numbers at step 508. It should be noted that it is unimportant whether the call is inbound or outbound, the phone, or service provider, obviously has an outbound number available as entered by the subscriber and has inbound numbers available through caller ID.

At step 508, if the number is not in the list of allowed numbers, the call is terminated at step 510. If the number is in the list, the call is allowed and the system returns to monitor the speed of the cell phone. Associated with the call termination of 510 there may be an aural warning and/or a visual warning provided to the subscriber to indicate that the call was disallowed. It should also be noted that after the call is terminated, control preferably returns to step 502 to resume monitoring of the cell phone speed.

It should be noted that while velocity is typically a vector having a magnitude and direction and speed is typically a scalar quantity providing a magnitude without direction, the present invention can use either such quantity to provide the inventive function. Since either velocity or speed provides the information necessary to practice the present invention, for purposes of this invention the terms are used interchangeably.

It should also be noted that a subscriber's vehicle may provide the functions of steps 502 and 504 and communicate either the speed or a binary determination of the exceeded threshold to the cell phone. By way of example and not limitation, it could be assumed that if the ignition is on, or other indicator that the car is under the control of a driver, it can be assumed that the threshold is exceeded and a disallowed call thus prohibited.

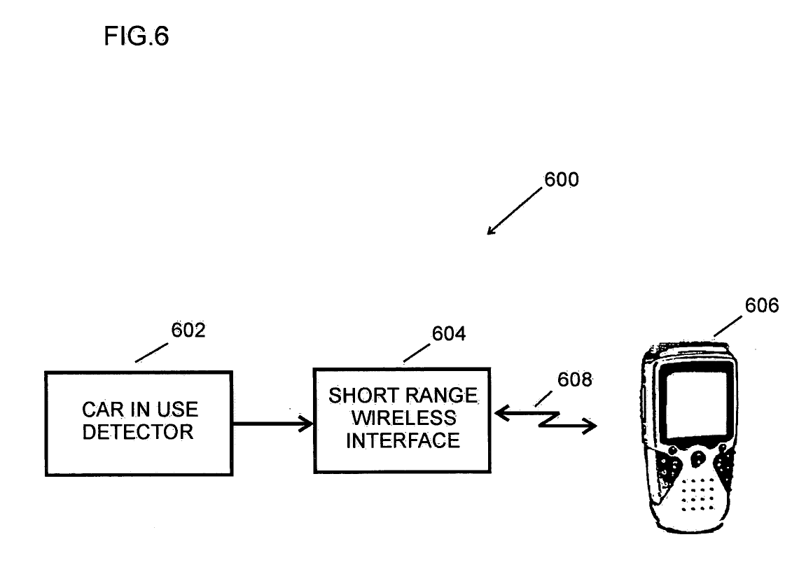

In one preferred embodiment of the present invention, in FIG. 6, the cell phone 606 further includes a local wireless interface 604. A similar interface 602 mounted in a car would be activated when the car was turned on. The car's interface 602 would communicate with the cell phone's interface 604. The connection of this communication would be the signal to disable the cell phone's 606 calling and receiving capabilities. The absence of the wireless communication between the car and the phone would re-enable the cell phone's 606 calling and receiving capabilities. This would allow the phone to be used in other vehicles or while moving but not in the owner's vehicle.

Thus, the present invention is well adapted to carry out the objects and attain the ends and advantages mentioned above as well as those inherent therein. While presently preferred embodiments have been described for purposes of this disclosure, numerous changes and modifications will be apparent to those skilled in the art. Such changes and modifications are encompassed within the spirit of this invention.

1. A motion disabling feature for a cell phone comprising:
a motion detection system which provides an indication that the cell phone is in motion;
a processor in communication with said motion detection system, said processor being capable of disrupting or terminating phone calls to or from the cell phone when said motion detection system indicates said cell phone is in motion.

2. The motion disabling feature for a cell phone of claim 1 wherein said motion detection system is a GPS receiver housed within the cell phone.

3. The motion disabling feature for a cell phone of claim 2 wherein said processor is a microprocessor which controls the user interface of the cell phone.

4. The motion disabling feature for a cell phone of claim 1 wherein said motion detection system is an inertial system receiver housed within the cell phone.

5. The motion disabling feature for a cell phone of claim 4 wherein said processor is a microprocessor which controls the user interface of the cell phone.

6. The motion disabling feature for a cell phone of claim 1 wherein said motion detection system is located at a service provider for the cell phone and comprises a system for providing a position of the cell phone based on relative received signal strength at a plurality of receiving antennas.

7. The motion disabling feature for a cell phone of claim 6 wherein said processor is located at the service provider.

8. The motion disabling feature for a cell phone of claim 1 wherein said motion detection system is located at a service provider for the cell phone and comprises a system for providing a position of the cell phone based on time-of-flight triangulation of an RF signal to a plurality of receiving antennas.

9. The motion disabling feature for a cell phone of claim 6 wherein said processor is located at the service provider.

10. A method for disabling a cell phone in motion comprising the steps of:
(a) determining a speed of the cell phone;
(b) comparing said speed to a predetermined threshold;
(c) if said speed exceeds said predetermined threshold, determining if a call is in progress or being attempted to or from the cell phone;
(d) if a call is in progress or being attempted, disrupting said call.

11. The method for disabling a cell phone in motion of claim 10 wherein step (d) includes the steps of:
(d)(i) maintaining a list of allowed phone numbers;
(d)(ii) determining a current phone number from which said call is coming or to which said call is placed;
(d)(iii) searching said list to determine if said current phone number is in said list of allowed numbers;
(d)(iv) if a call is in progress or being attempted and said current phone number is not in said list, disrupting said call.

12. An automobile proximity disabling feature for a cell phone comprising:
A wireless automobile detection system which provides an indication that the cell phone is in the proximity of an automobile;
a processor in communication with said automobile proximity detection system, said processor being capable of disrupting or terminating phone calls to or from the cell phone when said automobile proximity detection system indicates said cell phone is in the proximity of an automobile.
